(19) United States
(12) Patent Application Publication
(10) Pub. No.: US 2025/0244856 A1
(43) Pub. Date: Jul. 31, 2025

(54) MEASUREMENT APPARATUS AND MEASUREMENT TARGET SETTING METHOD THEREOF

(71) Applicant: ANRITSU CORPORATION, Kanagawa (JP)

(72) Inventors: Yasuko UDA, Kanagawa (JP); Ayako MIYOSHI, Kanagawa (JP)

(21) Appl. No.: 19/037,936

(22) Filed: Jan. 27, 2025

(30) Foreign Application Priority Data
Jan. 29, 2024 (JP) 2024-010960

(51) Int. Cl. G06F 3/04842; H04L 47/783

(52) U.S. Cl. CPC G06F 3/04842; H04L 47/783; G06F 2203/04806

(57) ABSTRACT

A plurality of resource unit display parts, which are graphic forms indicating resource units disposed in a frequency bandwidth of a channel, are displayed on a display part in a selectable manner in a case in which measurement of communication in accordance with a standard of IEEE 802.11 is performed, display of the display selection part is divided into a plurality of the display selection parts in a frequency direction to display one display selection part in an enlarged manner in the frequency direction in a case in which the frequency bandwidth of the channel is equal to or greater than a predetermined value, and selection of at least one of the plurality of resource unit display parts is allowed to allocate the resource unit as a measurement target.

### TECHNICAL FIELD

The present invention relates to a measurement apparatus, and more particularly to a measurement apparatus that measures radio signals transmitted and received by a communication apparatus that operates in accordance with a communication standard of a wireless local area network (LAN).

### BACKGROUND ART

Various wireless communication technologies are developed with development of: communication technologies. Among these, as a communication standard related to a wireless LAN technology, for example, institute of electrical and electronics engineers (IEEE) 802.11ac or IEEE 802.11ax is known.

In the IEEE 802.11ax, orthogonal frequency division multiple access (OFDMA) is adopted such that a larger number of users can use the same frequency bandwidth.

In the OFDMA of the IEEE 802.11ax, a frequency band of a channel is divided into sub-channels, each sub-channel is allocated to each user, and the frequency band of the channel can be used by a plurality of users.

In Patent Document 1, in a measurement apparatus that measures communication of the IEEE 802.11ax standard, a plurality of graphic forms indicating sub-channels in the channel bandwidth are displayed on a display part, and a sub-channel as a measurement target is selected.

### RELATED ART DOCUMENT

### Patent Document

### Patent Document 1

JP-A-2021-022868

### DISCLOSURE OF THE INVENTION

### Problem that the Invention is to Solve

Recently, IEEE 802.11be, which is an extremely high throughput (EHT) wireless LAN standard, is proposed as the next version of the IEEE 802. 11ax.

In the orthogonal frequency division multiple access (OFDMA) of the IEEE 802.11be, it is possible to divide a frequency band of a channel of a predetermined frequency bandwidth used for the communication into a plurality of resource units (RU), and to allocate the plurality of resource units to one terminal.

However, in a case in which the plurality of resource units are selected, a selectable resource unit is determined in the standard, and the selection cannot be freely performed.

In a case in which the measurement of the communication of the IEEE 802.11be is performed as described above, the measurement in which the resource unit is specified is required, but in the communication using the plurality of resource units, the selectable resource unit should be selected in accordance with the standard, and thus mistake of the user easily occurs, and there is a problem that the usability is deteriorated, such as taking time and effort to setting.

In addition, in the IEEE 802.11be, a case is also defined in which the frequency bandwidth is 320 MHZ, but in a case in which a graphic form indicating the resource unit is to be displayed on one screen as in Patent Document 1, there is a portion in which the graphic form is small, it is difficult to understand the selection of the resource unit to be measured, and thus the mistake of the user easily occurs, and there is a problem that the usability is deteriorated, such as taking time and effort to setting.

Therefore, the present invention is to provide a measurement apparatus that can easily designate a desired measurement target without any mistake in the measurement of the communication in the IEEE 802.11.

### Means for solving the problem

An aspect of the present invention relates to a measurement apparatus (1) that measures transmission/reception characteristics of a communication apparatus (100) that transmits and receives radio signals, the measurement apparatus including: a display part (15) that displays an image; an operation part (14) that outputs information input by an operation using an input device to a control part (16); an enlarged-display button (137) that displays an RU configuration image enlarged in a frequency direction; a display selection part (111, 112, 113, 114, 115, 116, 117, 118) in which a resource unit display part (120) representing a resource unit is displayed in a number corresponding to the number of the resource units; and a control part (16) that displays a plurality of the resource unit display parts (120), which are graphic forms indicating the resource units disposed in a frequency bandwidth of a channel, on the display part in a selectable manner in a case in which measurement of communication in accordance with a standard of IEEE 802.11 is performed, that divides display of the display selection part into a plurality of the display selection parts in the frequency direction to display one display selection part in an enlarged manner in the frequency direction in a case in which the frequency bandwidth of the channel is equal to or greater than a predetermined value, and the enlarged-display button is selected by an operation on the operation part, and that allows selection of at least one of the plurality of resource unit display parts to allocate the resource unit as a measurement target.

With this configuration, in a case in which the frequency bandwidth of the channel is equal to or greater than the predetermined value, the display of the display selection part is divided into a plurality of parts in the frequency direction, and one of the plurality of parts is enlarged and displayed in the frequency direction. Therefore, a size of the resource unit display part can be set to a size that is easily discriminated, and a desired measurement target can be easily designated without any mistake.

In addition, in the measurement apparatus according to the aspect of the present invention, in a case in which the display selection part is displayed in an enlarged manner in the frequency direction, and a movement button (138) is selected by the operation on the operation part, the control part may move a screen in the frequency direction by the operation on the operation part.

With this configuration, in a case in which the display selection part is enlarged and displayed in the frequency direction, and the movement button is selected by the operation on the operation part, the screen is moved in the frequency direction by the operation on the operation part. Therefore, the frequency band to be displayed can be easily changed while setting the size of the resource unit display part to a size that is easily discriminated, and a desired measurement target can be easily designated without any mistake.

In addition, in the measurement apparatus according to the aspect of the present invention, in a case in which the display selection part is displayed in an enlarged manner in the frequency direction, and a reduced-display button (139) is selected by an operation on the operation part, the control part may display the display selection part that displays an entire frequency bandwidth of the channel.

With this configuration, in a case in which the display selection part is enlarged and displayed in the frequency direction, and the reduced-display button is selected by the operation on the operation part, the display selection part that displays the entire frequency bandwidth of the channel is displayed. Therefore, the enlarged image and the image in which the entire frequency bandwidth is displayed can be easily switched, and a desired measurement target can be easily designated without any mistake.

Another aspect of the present invention relates to a measurement target setting method of a measurement apparatus (1) that includes a display part (15) that displays an image, an operation part (14) that outputs information input by an operation using an input device to a control part (16), an enlarged-display button (137) that displays an RU configuration image enlarged in a frequency direction, and a display selection part (111, 112, 113, 114, 115, 116, 117, 118) in which a resource unit display part (120) representing a resource unit is displayed in a number corresponding to the number of the resource units, the measurement apparatus measuring transmission/reception characteristics of a communication apparatus (100) that transmits and receives radio signals,, the measurement target setting method including: a step of displays a plurality of the resource unit display parts (120), which are graphic forms indicating the resource units disposed in a frequency bandwidth of a channel, on the display part in a selectable manner in a case in which measurement of communication in accordance with a standard of IEEE 802.11 is performed; a step of dividing display of the display selection part into a plurality of the display selection parts in the frequency direction to display one display selection part in an enlarged manner in the frequency direction in a case in which the frequency bandwidth of the channel is equal to or greater than a predetermined value, and the enlarged-display button is selected by an operation on the operation part; and a step of allowing selection of at least one of the plurality of resource unit display parts to allocate the resource unit as a measurement target.

In addition, in the measurement target setting method according to the aspect of the present invention, in a case in which the display selection part is displayed in an enlarged manner in the frequency direction, and a movement button (138) is selected by the operation on the operation part, a screen may be moved in the frequency direction by the operation on the operation part.

In addition, in the measurement target setting method according to the aspect of the present invention, in a case in which the display selection part is displayed in an enlarged manner in the frequency direction, and a reduced-display button (139) is selected by the operation on the operation part, the display selection part that displays an entire frequency bandwidth of the channel may be displayed.

With this configuration, in a case in which the frequency bandwidth of the channel is equal to or greater than the predetermined value, the display of the display selection part is divided into a plurality of parts in the frequency direction, and one of the plurality of parts is enlarged and displayed in the frequency direction. Therefore, a size of the resource unit display part can be set to a size that is easily discriminated, and a desired measurement target can be easily designated without any mistake.

### Advantage of the Invention

The present invention can provide the measurement apparatus that can easily designate the desired measurement target without any mistake in the measurement of the communication of the IEEE 802.11.

### BRIEF DESCRIPTION OF THE DRAWINGS

FIG. 1 is a block diagram of a measurement apparatus according to an embodiment of the present invention.

FIG. 2 is a diagram illustrating an example of a wireless communication setting image of the measurement apparatus according to the embodiment of the present invention.

FIG. 3 is a diagram illustrating a combination of RUs in accordance with a type of an MRU and an index of the MRU in a case in which a frequency bandwidth of a channel is 20 MHz in IEEE 802.11be.

FIG. 4 is a diagram illustrating a resource unit configuration image in a case in which the frequency bandwidth of the channel of the measurement apparatus according to the embodiment of the present invention is 20 MHz.

FIG. 5 is a diagram illustrating a resource unit configuration image in a case in which the frequency bandwidth of the channel of the measurement apparatus according to the embodiment of the present invention is 40 MHZ.

FIG. 6 is a diagram illustrating a resource unit configuration image in a case in which the frequency bandwidth of the channel of the measurement apparatus according to the embodiment of the present invention is 80 MHZ.

FIG. 7 is a diagram illustrating a resource unit configuration image in a case in which the frequency bandwidth of the channel of the measurement apparatus according to the embodiment of the present invention is 160 MHZ.

FIG. 8 is a diagram illustrating a resource unit configuration image in a case in which the frequency bandwidth of the channel of the measurement apparatus according to the embodiment of the present invention is 320 MHZ.

FIG. 9 is a diagram illustrating an enlarged resource unit configuration image in a case in which the frequency bandwidth of the channel of the measurement apparatus according to the embodiment of the present invention is 320 MHZ.

### BEST MODE FOR CARRYING OUT THE INVENTION

Hereinafter, a measurement apparatus according to an embodiment of the present invention will be described in detail with reference to the drawings.

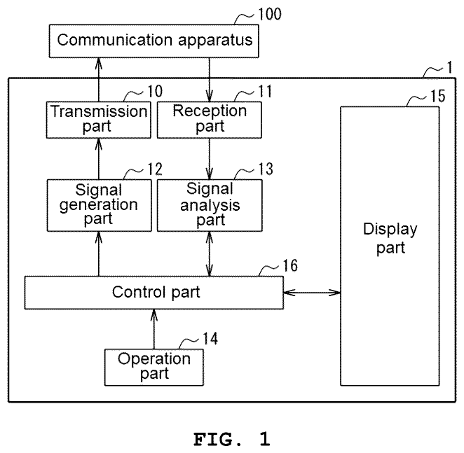

In FIG. 1, a measurement apparatus 1 according to the embodiment of the present invention performs wireless communication with a communication apparatus 100 and performs various types of measurement on radio signals transmitted and received by the communication apparatus 100.

In the present embodiment, the measurement apparatus 1 operates as a wireless LAN access point (AP) and the communication apparatus 100 operates as a wireless LAN station (STA), but the measurement apparatus 1 and the communication apparatus 100 are not limited to these, and the measurement apparatus 1 may operate as the STA and the communication apparatus 100 may operate as the AP. It should be noted that the measurement apparatus 1 communicates with the communication apparatus 100 in accordance with communication standard conforming to IEEE 802.11.

The measurement apparatus 1 includes a transmission part 10, a reception part 11, a signal generation part 12, a signal analysis part 13, an operation part 14, a display part 15, and a control part 16.

The transmission part 10 performs amplification or frequency conversion on signals generated by the signal generation part 12, and transmits the signals to the communication apparatus 100.

The reception part 11 performs amplification or frequency conversion on radio signals received from the communication apparatus 100, and outputs the radio signals to the signal analysis part 13.

The signal generation part 12 generates signals including a control packet or a data packet for communicating with the communication apparatus 100, and transmits the signals to the communication apparatus 100 via the transmission part 10.

The signal analysis part 13 analyzes the radio signals received from the communication apparatus 100 via the reception part 11, and performs a process of measuring transmission/reception characteristics of the communication apparatus 100. The transmission/reception characteristics include a packet error rate, error vector magnitude (EVM), transmission power, and the like.

The operation part 14 includes input devices, such as a keyboard, a cursor, and a touch panel, and outputs information input by an operation to the control part 16. A pointer other than the mouse may be used as the cursor.

The display part 15 includes an image display device, such as a liquid crystal display, and displays an image for inputting information required for the measurement, an image indicating a measurement result, or the like.

The control part 16 is configured of a computer unit including a central processing unit (CPU), a random access memory (RAM), a read only memory (ROM), a hard disk device, and an input/output port (all of which are not illustrated).

The ROM and the hard disk device of this computer unit store a program for causing the computer unit to function as the control part 16 together with various control constants, various maps, or the like. That is, by the CPU executing the program stored in the ROM and the hard disk device, the computer unit functions as the control part 16. It should be noted that the hard disk device may be a compact flash (CF) card using a flash memory.

The signal generation part 12, the signal analysis part 13, the operation part 14, and the display part 15 are connected to the input/output port of the control part 16, and the control part 16 and each part can transmit and receive the signals to and from each other.

The measurement apparatus 1 according to the present embodiment can perform measurement of the communication in accordance with a standard of IEEE 802.11be.

In the IEEE 802.11be, the communication is performed by dividing a channel of a predetermined frequency bandwidth used for the communication into resource units consisting of a predetermined number of sub-carriers, and allocating a terminal for each resource unit or allocating a plurality of resource units to one terminal.

The minimum number of sub-carriers configuring the resource unit is 26 (26-tone RU), and there are further 52 (52-tone RU), 106 (106-tone RU), 242 (242-tone RU), 484 (484-tone RU), 996 (996-tone RU), or the like. The frequency bandwidth of the channel is 20 MHZ, 40 MHZ, 80 MHz, 160 MHZ, 320 MHz, or the like.

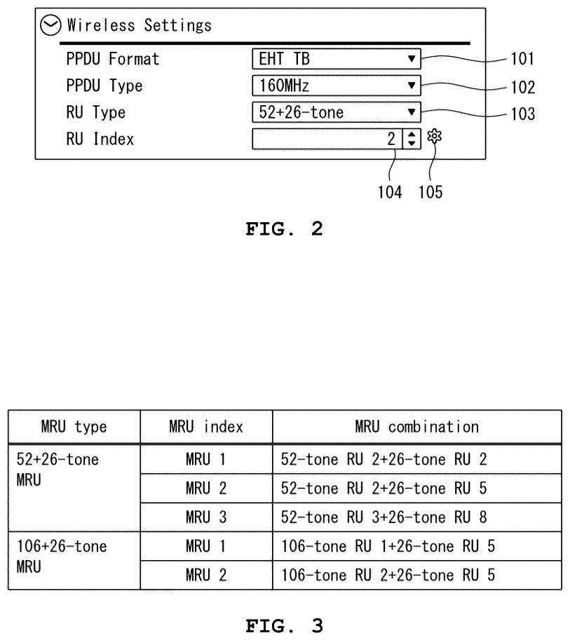

The control part 16 displays an image (wireless setting image) as illustrated in FIG. 2 on the display part 15 to perform settings of wireless communication.

In FIG. 2, a PPDU format selection part 101 allows the selection of a format of a physical layer convergence protocol (PLCP) protocol data unit (PPDU).

A PPDU type selection part 102 allows the selection of the frequency bandwidth of the channel. The frequency bandwidth of the channel is selectable from among, for example, 20 MHz, 40 MHz, 80 MHZ, 160 MHZ, and 320 MHZ.

In a case in which “EHT TB” is selected in the PPDU format selection part 101, the control part 16 displays an RU type setting part 103, an RU index setting part 104, and an RU allocation selection icon 105.

The RU type setting part 103 allows the setting of a type of the RU defined by the standard. For example, a case in which only one RU is allocated as the type of the RU, such as 26, 52, 106, 242, 484, 996, 2×996, or 4×996, is referred to as a Single RU (SRU).

A case in which a plurality of RUs are allocated as the type of the RU, such as 52+26, 106+26, 484+242, or 996+484, is referred to as Multiple RU (MRU).

The RU index setting part 104 allows the setting of the index of the RU, which is defined by the standard, of the single RU or the multiple RU.

In the IEEE 802.11be, for example, in a case of the MRU, a combination of the RUs to be used is defined by the type of the MRU and the index of the MRU, as illustrated in FIG. 3. It should be noted that FIG. 3 illustrates the combination of the RUs in a case in which the frequency bandwidth of the channel is 20 MHZ.

In this way, the resource unit is selectable in accordance with the type of the MRU and the index of the MRU defined by the standard, and the resource unit of the MRU can be easily selected.

It should be noted that the control part 16 prohibits the settings other than the type of the RU and the index of the RU which are allocated by the standard, in the RU type setting part 103 and the RU index setting part 104.

For example, the RU type setting part 103 displays the types of the RU defined by the standard in a drop-down list for the selection. In the RU index setting part 104, only the index of the RU selectable by the type of the RU selected in the RU type setting part 103 can be set, and in a case in which the index of an unselectable RU is set, the setting is canceled, and the original value is restored.

In addition, in a case in which the value set in the RU index setting part 104 is an unselectable value when the type of the RU is set in the RU type setting part 103, the control part 16 sets the minimum value among the indices of the selectable RU in the RU index setting part 104.

In a case in which, for example, the RU allocation selection icon 105 is selected by being clicked by the cursor of the operation part 14, the control part 16 displays an image of a configuration image of the RU (RU configuration image) corresponding to the frequency bandwidth selected in the PPDU type selection part 102 on the display part 15, and allocates the RU as the measurement target.

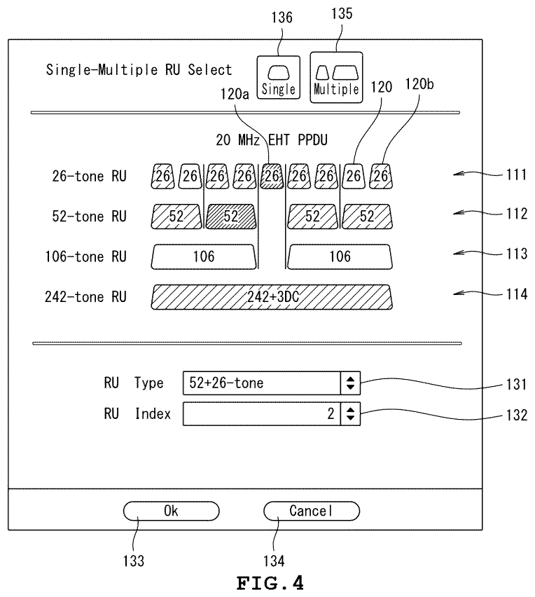

In a case in which the frequency bandwidth selected in the PPDU type selection part 102 is 20 MHz and the type of the RU selected in the RU type setting part 103 is the MRU, the control part 16 displays the image as illustrated in FIG. 4 on the display part 15, and allocates the RU as the measurement target. A horizontal direction in FIG. 4 represents the frequency band, and the frequency is higher toward the right.

In FIG. 4, in a 26-tone display selection part 111, which is a group in a row direction, the resource units for the 26-tone RU are displayed for the selection. In a 52-tone display selection part 112, the resource units for the 52-tone RU are displayed for the selection. In a 106-tone display selection part 113, the resource units for the 106-tone RU are displayed for the selection. In a 242-tone display selection part 114, the resource units for the 242-tone RU are displayed for the selection.

In each display selection part, resource unit display parts 120 representing the respective resource units are displayed by the number of the resource units. The resource unit display part 120 represents, for example, the frequency bandwidth of each resource unit and a position on the frequency bandwidth of the channel with an approximately trapezoidal graphic form.

In this way, it is possible to easily check a position of the resource unit being selected or the resource unit to be selected, and it is possible to easily designate the desired measurement target without any mistake.

The control part 16 changes and displays the display of the resource unit display part 120 between unselected, being selected (=selected), and unselectable. Unselectable indicates the resource unit that is not available in the selected PPDU type. Unselected indicates the resource unit that is available in the selected PPDU type but is not selected.

For example, the control part 16 displays, for example, the display of the resource unit display part 120 being selected, as in a resource unit display part 120a. For example, the control part 16 displays, for example, the display of the unselectable resource unit display part 120 as in a resource unit display part 120b. The resource unit display part 120a and the resource unit display part 120b are different from each other such that the display modes can be distinguished.

In this way, since the display of the resource unit display part 120 is changed between unselected, being selected, and unselectable, it is possible to easily check the unselectable resource unit, and it is possible to easily designate the desired measurement target without any mistake.

For example, based on the type of the RU and the index of the RU, which are set in the RU type setting part 103 and the RU index setting part 104 in FIG. 2, the control part 16 sets the display of the resource unit display part 120 of the resource unit determined from the type of the RU and the index of the RU, which are set, as being selected, sets the display of the resource unit display part 120 of the unselectable resource unit determined from the type of the RU and the index of the RU, which are set, as unselectable, and sets the display of the resource unit display part 120 of the selectable resource unit determined from other set types of the RU as unselected.

In this way, it is possible to easily check the position of the resource unit being selected, and it is possible to easily designate the desired measurement target without any mistake.

The RU type setting part 131 can display the type of the RU set in the RU type setting part 103 in FIG. 2 as an initial value, and can set the type of the RU by the operation of the user.

The RU index setting part 132 can display the index of the RU set by the RU index setting part 104 in FIG. 2 as an initial value, and can set the index of the RU by the operation of the user.

In this way, it is possible to select the resource unit in accordance with the type of the RU and the index of the RU defined by the standard, and it is possible to easily select the resource unit of the MRU.

The control part 16 switches the display of the resource unit display parts 120 in accordance with, for example, the settings of the RU type setting part 131 and the RU index setting part 132.

For example, the control part 16 sets the display of the resource unit display part 120 of the RU determined from the type of the RU and the index of the RU, which are set in the RU type setting part 131 and the RU index setting part 132, as being selected, sets the display of the resource unit display part 120 of the unselectable RU determined from the type of the RU and the index of the RU, which are set, as unselectable, and sets the display of the resource unit display part 120 of the selectable RU determined from other set types of the RU as unselected.

In this way, it is possible to select the resource unit in accordance with the type of the RU and the index of the RU defined by the standard, and it is possible to easily check the position of the selected resource unit.

Further, in a case in which the resource unit display part 120 displayed as unselected is selected by, for example, performing a click operation by the operation of the cursor of the operation part 14, the control part 16 switches the display of the resource unit display part 120 of the RU corresponding to the selected RU as being selected, and switches the display of the RU type setting part 131 and the RU index setting part 132 in accordance with the selected RU.

For example, in a case in which there are a plurality of combinations of the selected RUs, the control part 16 adopts the combination in which the value of the index of the MRU is the minimum, and switches the display.

In this way, it is possible to select the resource unit of the measurement target from the configuration image of the resource unit, and it is possible to easily designate the desired measurement target without any mistake.

In addition, since the resource unit paired with the selected resource unit is automatically being selected, it is possible to easily designate the desired measurement target without any mistake.

In addition, it is possible to check the type of and the index of the MRU of the selected resource unit from the configuration image of the resource unit, and it is possible to easily designate the desired measurement target without any mistake.

Further, in a case in which any of the resource unit display parts 120 of the unselected RUs is selected by performing the click operation by the operation of the cursor of the operation part 14, the control part 16 displays the resource unit display part 120 of the RU of a candidate to be paired with the selected RU as a candidate different from unselected, being selected, and unselectable. It should be noted that, in a case in which the combination of the RUs is uniquely determined by the first selected RU, the resource unit display part 120 of the corresponding second RU is also displayed as being selected.

In this way, since the display of the resource unit as the candidate to be paired with the selected resource unit is changed, it is possible to easily designate the desired measurement target without any mistake.

In addition, in a case in which the resource unit paired with the selected resource unit is uniquely determined, since the resource unit is automatically being selected, it is possible to easily designate the desired measurement target without any mistake.

It should be noted that the control part 16 may switch the display of the resource unit display parts 120 in accordance with the settings of the RU type setting part 131 and the RU index setting part 132.

In this way, it is possible to easily check the position of the resource unit selected by the settings of the RU type setting part 131 and the RU index setting part 132.

Also, the settings may be performed in the RU type setting part 103, the RU index setting part 104, the RU type setting part 131, and the RU index setting part 132, and the resource unit display part 120 may be used to only check the display.

In FIG. 4, a confirm button 133 allows the confirmation of the setting of the resource unit being selected. In a case in which the confirm button 133 is selected by the operation of the operation part 14, the control part 16 sets the resource unit, being selected, corresponding to the resource unit display part 120a, as the resource unit as the measurement target, and returns the display of the display part 15 to the display of FIG. 2 (display in FIG. 4 disappears). In this case, the control part 16 displays the type of the selected resource unit in the RU type setting part 103 and the index in the RU index setting part 104.

In FIG. 4, a cancel button 134 allows the cancellation of the changed setting of the resource unit being selected. In a case in which the cancel button 134 is selected by the operation of the operation part 14, the control part 16 sets the resource unit selected before displaying the image in FIG. 4 as the resource unit as the measurement target, and returns the display of the display part 15 to the display of FIG. 2. In this case, the control part 16 displays the type of the resource unit before displaying the image of FIG. 4 in the RU type setting part 103 and the index in the RU index setting part 104.

An MRU switching button 135 switches the type of the RU to the MRU. An SRU switching button 136 switches the type of the RU to SRU. In a case in which the MRU switching button 135 is selected by the click operation by the operation of the cursor of the operation part 14, the control part 16 switches the type of the RU to the MRU. In a case in which the SRU switching button 136 is selected by the click operation by the operation of the cursor of the operation part 14, the control part 16 switches the type of the RU to the SRU.

In a case in which the type of the RU is the MRU, the control part 16 displays the MRU switching button 135 to be larger than the SRU switching button 136 as illustrated in FIG. 4. In a case in which the type of the RU is the SRU, the control part 16 displays the SRU switching button 136 to be larger than the MRU switching button 135, contrary to the illustration of FIG. 4.

In this way, it is possible to easily know whether the type of the RU that is being currently selected is the SRU or the MRU, and it is possible to easily designate the desired measurement target without any mistake.

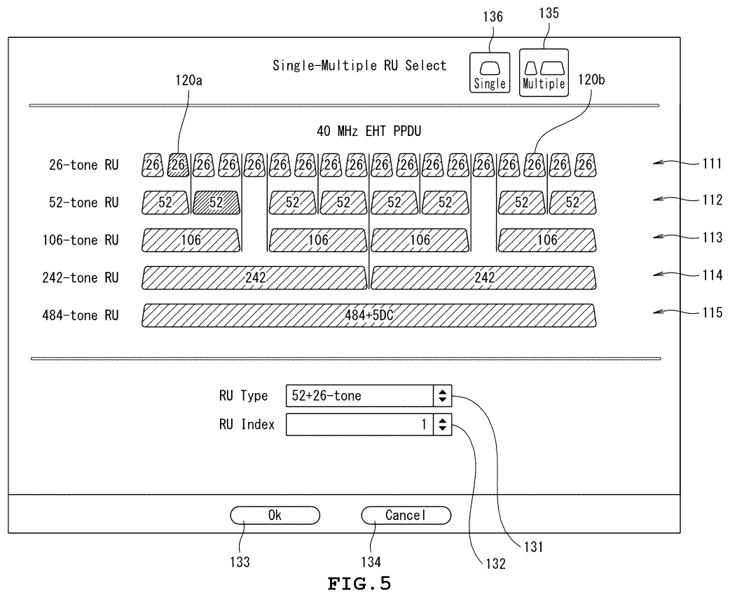

In a case in which the frequency bandwidth selected in the PPDU type selection part 102 is 40 MHZ, the control part 16 displays the image as illustrated in FIG. 5 on the display part 15, and allocates the RU as the measurement target.

In FIG. 5, in addition to a case in which the frequency bandwidth is 20 MHz, a 484-tone display selection part 115 is displayed. In the 484-tone display selection part 115, the resource units for 484-tone RU are displayed for the selection.

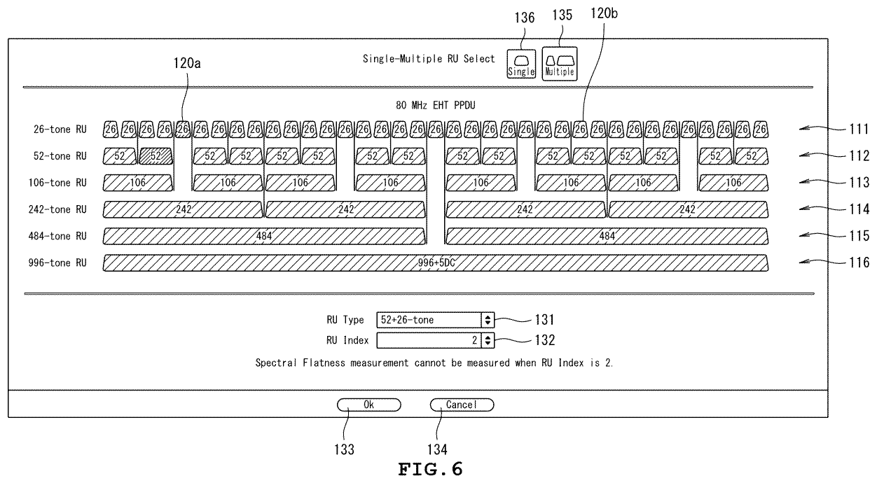

In a case in which the frequency bandwidth selected in the PPDU type selection part 102 is 80 MHZ, the control part 16 displays the image as illustrated in FIG. 6 on the display part 15, and allocates the RU as the measurement target.

In FIG. 6, in addition to a case in which the frequency bandwidth is 40 MHz, a 996-tone display selection part 116 is displayed. In the 996-tone display selection part 116, the resource units for 996-tone RU are displayed for the selection.

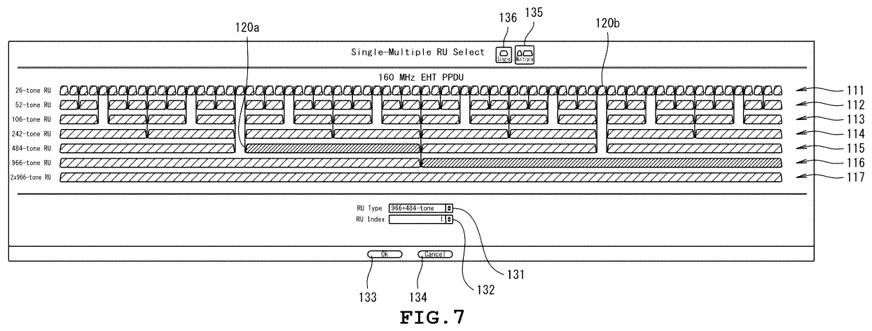

In a case in which the frequency bandwidth selected in the PPDU type selection part 102 is 160 MHZ, the control part 16 displays the image as illustrated in FIG. 7 on the display part 15, and allocates the RU as the measurement target.

In FIG. 7, in addition to a case in which the frequency bandwidth is 80 MHZ, a 2×996-tone display selection part 117 is displayed. In the 2×996-tone display selection part 117, the resource units for 2×996-tone RU are displayed for the selection.

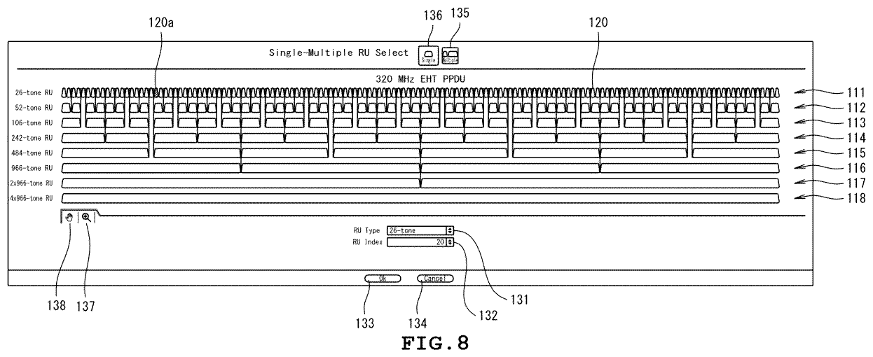

In a case in which the frequency bandwidth selected in the PPDU type selection part 102 is 320 MHz, the control part 16 displays the image as illustrated in FIG. 8 on the display part 15, and allocates the RU as the measurement target. It should be noted that FIG. 8 illustrates a case in which the type of the RU is the SRU.

In FIG. 8, in addition to a case in which the frequency bandwidth is 160 MHz, a 4×996-tone display selection part 118 is displayed. In the 4×996-tone display selection part 118, the resource units for 4×996-tone RU are displayed for the selection.

In a case in which the frequency bandwidth of the channel is 320 MHZ, and the entire 320 MHz is displayed on one screen, the graphic form of the 26-tone display selection part 111 is reduced in size, and it is difficult to select the RU or to check the selected RU.

Therefore, in the present embodiment, the control part 16 divides the display selection parts 111, 112, 113, 114, 115, 116, 117, and 118 into a plurality of display selection parts in the frequency direction (horizontal direction in the figure) by the operation on the operation part 14 while allowing the selection of the RU even in a case in which the graphic form of the 26-tone display selection part 111 in FIG. 8 is small, enlarges one of the divided display selection parts to display the enlarged divided display selection part, and allows the selection of the RU as the measurement target by the enlarged resource unit display part 120.

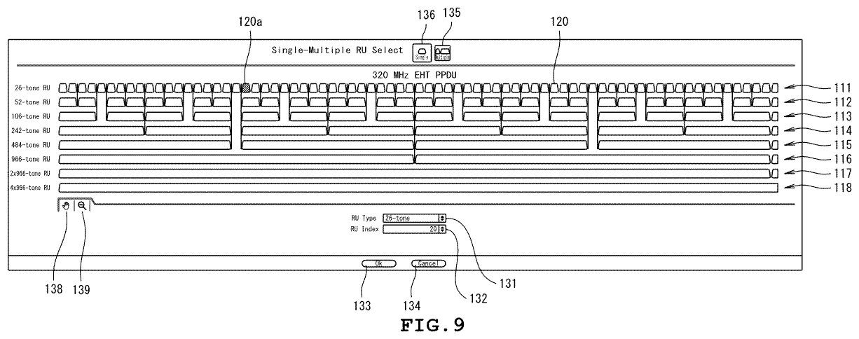

For example, in a case in which the enlarged-display button 137 is selected by the operation on the operation part 14 on the screen illustrated in FIG. 8, the control part 16 displays the RU configuration image enlarged in the frequency direction divided into two parts on the low-frequency side in the frequency direction by the display selection parts 111, 112, 113, 114, 115, 116, 117, and 118 as illustrated in FIG. 9.

In this way, the size of the resource unit display part 120 can be set to a size that is easily discriminated, and a desired measurement target can be easily designated without any mistake.

In addition, as illustrated in FIG. 9, in a case in which the display selection parts 111, 112, 113, 114, 115, 116, 117, and 118 are displayed in an enlarged manner in the frequency direction, the control part 16 moves the screen in the frequency direction (horizontal direction in the figure) by the operation on the operation part 14 in a case in which the movement button 138 is selected by the operation on the operation part 14. For example, the control part 16 moves the screen in the frequency direction by dragging the cursor of the operation part 14.

In this way, the frequency band to be displayed can be easily changed while setting the size of the resource unit display part 120 to a size that is easily discriminated, and a desired measurement target can be easily designated without any mistake.

In addition, in a case in which the reduced-display button 139 is selected by the operation on the operation part 14 on the screen illustrated in FIG. 9, the control part 16 displays the RU configuration image illustrated in FIG. 8.

In this way, the enlarged image and the image in which the entire frequency bandwidth is displayed can be easily switched, and a desired measurement target can be easily designated without any mistake.

It should be noted that, for example, the control part 16 displays, for example, the display of the resource unit display part 120 being selected, as in the resource unit display part 120a.

In addition, in a case in which the type of the RU is the MRU, the control part 16 performs the same control as in a case of the MRU described above.

The control part 16 uses the resource units set in this way to perform communication with the communication apparatus 100 to perform various types of measurement. For example, an operator selects and confirms the resource unit to be transmitted by the communication apparatus 100, by using the RU configuration image of FIG. 4. The transmission part 10 notifies the communication apparatus 100 of measurement conditions including the selected resource unit, and the communication apparatus 100 transmits back predetermined signals to the measurement apparatus 1 by the designated resource unit. The measurement apparatus 1 receives the signals transmitted back by the reception part 11, and measures the transmission characteristics and the like by the signal analysis part 13.

It should be noted that, in the present embodiment, although the measurement apparatus integrated with the operation part 14 or the display part 15 has been described as an example, for example, a configuration may be adopted in which the signal generation part 12 or the signal analysis part 13 is controlled from a program of a personal computer connected via a network or the like.

Also, in the present embodiment, the IEEE 802.11be has been described as an example, but the present invention can be applied to other communication standards that require the selection of the selectable resource units in accordance with the standard.

Although the embodiment of the present invention has been disclosed, it is apparent that modifications may be made by those skilled in the art without departing from the scope of the present invention. All such modifications and equivalents are intended to be included in the following claims.

### DESCRIPTION OF REFERENCE NUMERALS AND SIGNS

1 Measurement apparatus
14 Operation part
15 Display part
16 Control part
100 Communication apparatus
102 PPDU type selection part
103, 131 RU type setting part
104, 132 RU index setting part
105 RU allocation selection icon
111 26-tone display selection part (display selection part)
112 52-tone display selection part (display selection part)
113 106-tone display selection part (display selection part)
114 242-tone display selection part (display selection part)
115 484-tone display selection part (display selection part)
116 996-tone display selection part (display selection part)
117 2×996-tone display selection part (display selection part)
118 4×996-tone display selection part (display selection part)
120, 120a, 120b Resource unit display part
137 Enlarged-display button
138 Movement button
139 Reduced-display button

What is claimed is:

1. A measurement apparatus that measures transmission/reception characteristics of a communication apparatus that transmits and receives radio signals, the measurement apparatus comprising:
a display part that displays an image;
an operation part that outputs information input by an operation using an input device to a control part;
an enlarged-display button that displays an RU configuration image enlarged in a frequency direction;
a display selection part in which a resource unit display part representing a resource unit is displayed in a number corresponding to the number of the resource units; and
a control part that displays a plurality of the resource unit display parts, which are graphic forms indicating the resource units disposed in a frequency bandwidth of a channel, on the display part in a selectable manner in a case in which measurement of communication in accordance with a standard of IEEE 802.11 is performed, that divides display of the display selection part into a plurality of the display selection parts in the frequency direction to display one display selection part in an enlarged manner in the frequency direction in a case in which the frequency bandwidth of the channel is equal to or greater than a predetermined value, and the enlarged-display button is selected by an operation on the operation part, and that allows selection of at least one of the plurality of resource unit display parts to allocate the resource unit as a measurement target.

2. The measurement apparatus according to claim 1,
wherein, in a case in which the display selection part is displayed in an enlarged manner in the frequency direction, and a movement button is selected by the operation on the operation part, the control part moves a screen in the frequency direction by the operation on the operation part.

3. The measurement apparatus according to claim 1,
wherein, in a case in which the display selection part is displayed in an enlarged manner in the frequency direction, and a reduced-display button is selected by the operation on the operation part, the control part displays the display selection part that displays an entire frequency bandwidth of the channel.

4. The measurement apparatus according to claim 2,
wherein, in a case in which the display selection part is displayed in an enlarged manner in the frequency direction, and a reduced-display button is selected by an operation on the operation part, the control part displays the display selection part that displays an entire frequency bandwidth of the channel.

5. A measurement target setting method of a measurement apparatus that includes a display part that displays an image, an operation part that outputs information input by an operation using an input device to a control part, an enlarged-display button that displays an RU configuration image enlarged in a frequency direction, and a display selection part in which a resource unit display part representing a resource unit is displayed in a number corresponding to the number of the resource units, the measurement apparatus measuring transmission/reception characteristics of a communication apparatus that transmits and receives radio signals, the measurement target setting method comprising:
a step of displays a plurality of the resource unit display parts, which are graphic forms indicating the resource units disposed in a frequency bandwidth of a channel, on the display part in a selectable manner in a case in which measurement of communication in accordance with a standard of IEEE 802.11 is performed;
a step of dividing display of the display selection part into a plurality of the display selection parts in the frequency direction to display one display selection part in an enlarged manner in the frequency direction in a case in which the frequency bandwidth of the channel is equal to or greater than a predetermined value, and the enlarged-display button is selected by an operation on the operation part; and
a step of allowing selection of at least one of the plurality of resource unit display parts to allocate the resource unit as a measurement target.

6. The measurement target setting method according to claim 5,
wherein, in a case in which the display selection part is displayed in an enlarged manner in the frequency direction, and a movement button is selected by the operation on the operation part, a screen is moved in the frequency direction by the operation on the operation part.

7. The measurement target setting method according to claim 5,
wherein, in a case in which the display selection part is displayed in an enlarged manner in the frequency direction, and a reduced-display button is selected by the operation on the operation part, the display selection part that displays an entire frequency bandwidth of the channel is displayed.

8. The measurement target setting method according to claim 6,
wherein, in a case in which the display selection part is displayed in an enlarged manner in the frequency direction, and a reduced-display button is selected by the operation on the operation part, the display selection part that displays an entire frequency bandwidth of the channel is displayed.
